(19) United States
(12) Patent Application Publication
(10) Pub. No.: US 2022/0134434 A1
(43) Pub. Date: May 5, 2022

(54) SELECTIVE ENERGY EMISSION CONTROL IN 3D FABRICATION SYSTEMS

(71) Applicant: Hewlett-Packard Development Company, L.P., Spring, TX (US)

(72) Inventors: Krzysztof Nauka, Palo Alto, CA (US); Chuangyu Zhou, Palo Alto, CA (US)

(73) Assignee: Hewlett-Packard Development Company, L.P., Spring, TX (US)

(21) Appl. No.: 17/415,146

(22) PCT Filed: Jul. 19, 2019
(86) PCT No.: PCT/US2019/042681

§ 371 Date: Jun. 17, 2021

(51) Int. Cl. B22F 10/36; B22F 10/14; B22F 12/42; B29C 64/165; B29C 64/393; B29C 64/277; B33Y 10/00; B33Y 30/00; B33Y 50/02

(52) U.S. Cl. CPC B22F 10/36; B22F 10/14; B22F 12/42; B29C 64/165; B33Y 50/02; B29C 64/277; B33Y 10/00; B33Y 30/00; B29C 64/393

(57) ABSTRACT

According to examples, a three-dimensional (3D) fabrication system may include an agent delivery device, an energy generator, and a controller. The agent delivery device may selectively deposit an agent onto a layer of build material particles. In some examples, the agent may include a first substance and a second substance. The controller may control the energy generator to emit energy at selective levels. In some examples, the controller may determine a first energy level tuned to the first substance and a second energy level tuned to the second substance, and may control the energy generator to sequentially emit energy at the first energy level and at the second energy level onto the deposited agent and the layer of build material particles.

### BACKGROUND

In three-dimensional (3D) printing, an additive printing process may be used to make 3D solid parts from a digital model. Some 3D printing techniques are considered additive processes because they involve the application of successive layers or volumes of a build material, such as a powder or powder-like build material, to an existing surface (or previous layer). 3D printing often includes solidification of the build material, which for some materials may be accomplished through use of heat and/or a chemical binder.

### BRIEF DESCRIPTION OF THE DRAWINGS

Features of the present disclosure are illustrated by way of example and not limited in the following figure(s), in which like numerals indicate like elements, in which:

FIG. 1 shows a block diagram of an example 3D fabrication system for fabricating a 3D object;

FIG. 2A shows a diagram of example components of the example 3D fabrication system depicted in FIG. 1;

FIGS. 2B-2C, collectively show block diagrams of some of the components in the example 3D fabrication system depicted in FIGS. 1 and 2A;

FIG. 3 shows a bottom view of an example energy generator, for instance, the energy generator depicted in FIGS. 1, 2A, and 2C;

FIGS. 4 and 5, respectively, show flow diagrams of example methods for controlling an energy generator to sequentially apply energy at multiple levels onto a layer of build material particles; and

FIG. 6 shows a block diagram of an example apparatus that may include a non-transitory computer readable medium on which is stored machine readable instructions for causing an energy generator to emit energy onto an agent deposited onto a layer of build material particles.

### DETAILED DESCRIPTION

For simplicity and illustrative purposes, the present disclosure is described by referring mainly to examples. In the following description, numerous specific details are set forth in order to provide a thorough understanding of the present disclosure. It will be readily apparent however, that the present disclosure may be practiced without limitation to these specific details. In other instances, some methods and structures have not been described in detail so as not to unnecessarily obscure the present disclosure.

Throughout the present disclosure, the terms “a” and “an” are intended to denote at least one of a particular element. As used herein, the term “includes” means includes but not limited to, the term “including” means including but not limited to. The term “based on” means based at least in part on.

Disclosed herein are apparatuses, methods, and computer readable mediums for selectively controlling emission of energy onto an agent deposited on layers of build material particles. In some examples, a controller may control an energy generator that may generate energy, e.g., in the form of heat and/or light, at multiple energy levels such that energy at different energy levels may be applied sequentially onto areas of the layers. That is, for instance, an area of a layer may receive energy at a first energy level prior to receiving energy at a second energy level.

As discussed herein, the agent may include a first substance and a second substance and the controller may control the energy generator to cause a concentration of the first substance in the agent to be reduced prior to a concentration of the second substance being reduced. That is, for instance, the first energy level may be tuned to the first substance, e.g., tuned to an energy absorption property of the first substance, such that application of the energy at the first energy level may cause the first substance to evaporate. Likewise, the second energy level may be tuned to the second substance, e.g., tuned to an energy absorption property of the second substance, such that application of the energy at the second energy level may cause the second substance to evaporate. In these examples, the second energy level may be higher than the first energy level. In addition, the first energy level may not cause the second substance to evaporate or may cause the second substance to evaporate at a relatively slow rate. For instance, application of the first energy level may be an energy level associated with evaporation of the first substance, e.g., an energy level that may cause the first substance to reach a boiling point temperature of the first substance without causing the second substance from reaching a boiling point temperature of the second substance.

According to examples, the controller may control the energy generator to apply energy at the first energy level to cause the first substance to evaporate and thus reduce the concentration of the first substance in the agent. As the concentration of the first substance reduces, the concentration of the second substance may increase. When the concentration of the second substance, which may be a solvent for plastic, increases beyond a certain level corresponding to a third substance, e.g., plastic nanoparticles, in the agent, the second substance may begin to dissolve the third substance. After a certain time, e.g., when the third substance has sufficiently dissolved, as may have been determined through testing, the controller may control the energy generator to apply energy at the second energy level to cause the second substance to evaporate and thus reduce the concentration of the second substance in the agent. By reducing the concentration of the second substance, the rate at which the third substance dissolves may be reduced and/or stopped. Thus, for instance, the controller may control the length of time and/or the level at which the third substance dissolves through control of the timing at which the energy generator is activated to apply energy at the second energy level.

By way of example, the controller may control the application of energy at the first energy level to cause the first substance, e.g., water, to evaporate, thereby increasing the concentration level of the second substance, e.g., a solvent for plastic. The increase in the concentration level of the solvent may cause plastic nanoparticles in the agent to dissolve and coat build material particles on which the agent has been deposited. In addition, following a certain time, e.g., a time corresponding to an amount of time for the flow of the agent to be sufficient for proper binding of the build material particles, the controller may control the energy generator to apply energy at the second, higher, level to cause the solvent to evaporate, which may stop and/or reduce the plastic nanoparticles from dissolving and flowing further. This may also cause the dissolved plastic nanoparticles to solidify and bind the build material particles together.

Through implementation of the features of the present disclosure, energy at multiple levels may be applied in a controlled manner such that the flow of a substance, e.g., plastic nanoparticles, may precisely be controlled. As a result, build material particles, e.g., metallic build material particles, may be bound together in an accurate and efficient manner such that a green part and a resulting 3D object may be fabricated to have precise dimensions, increased mechanical strength, enhanced texture, and/or the like.

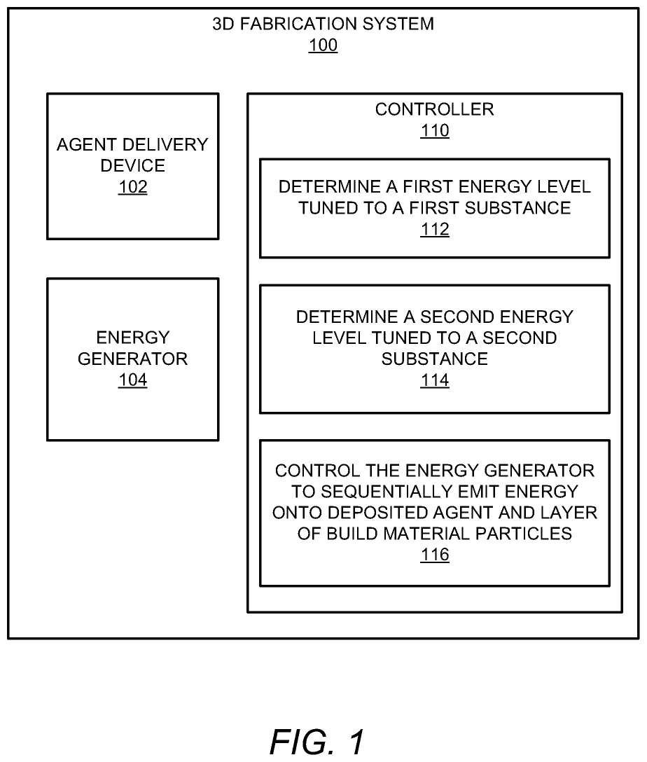

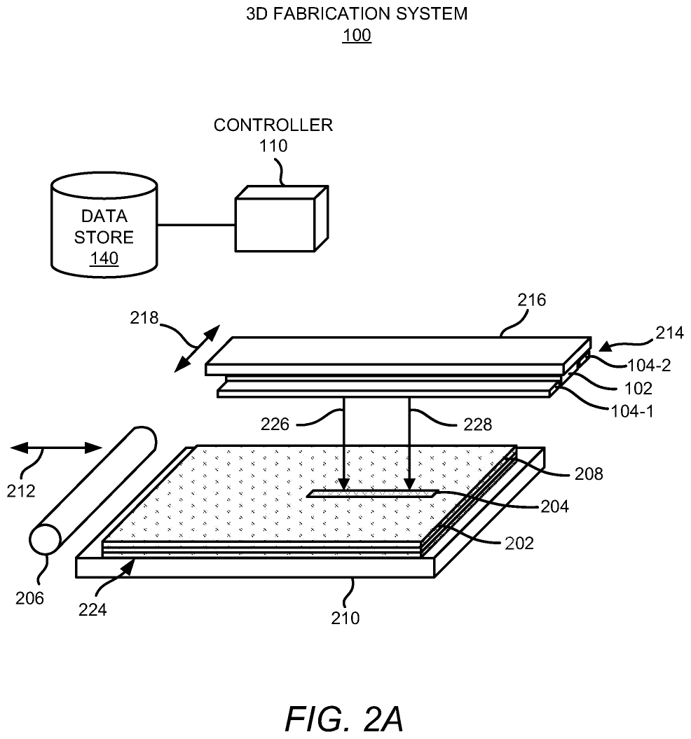

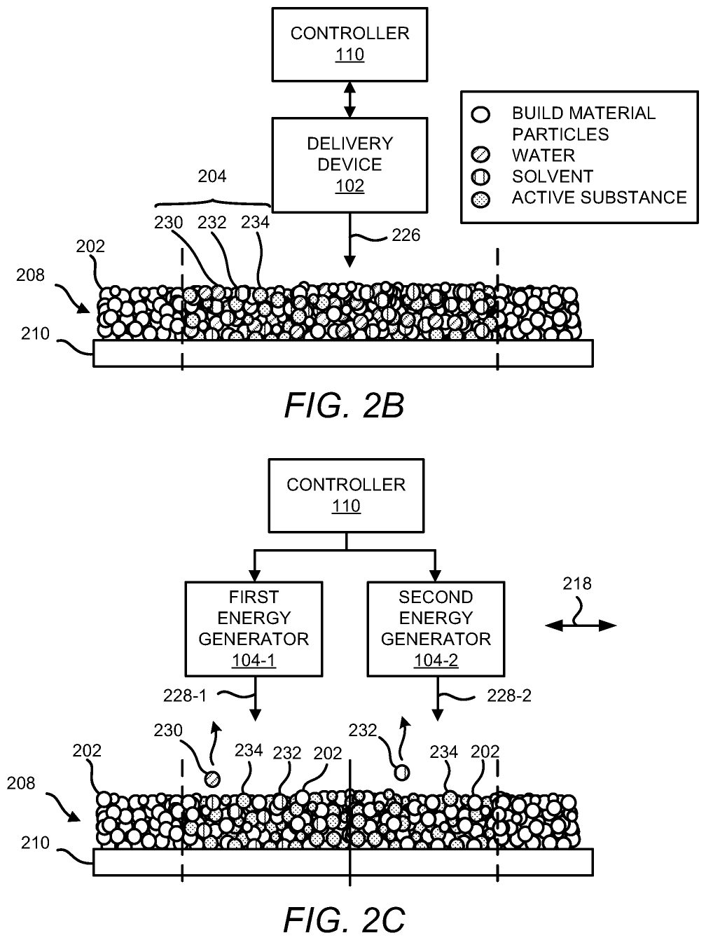

Reference is first made to FIGS. 1 and 2A. FIG. 1 shows a block diagram of an example 3D fabrication system 100 for fabricating a 3D object. FIG. 2A shows a diagram of example components of the example 3D fabrication system 100 depicted in FIG. 1. It should be understood that the example 3D fabrication system 100 depicted in FIGS. 1 and 2A may include additional features and that some of the features described herein may be removed and/or modified without departing from the scope of the 3D fabrication system 100.

With reference to FIGS. 1 and 2A, the 3D fabrication system 100, which may also be termed a 3D printing system, a 3D fabricator, or the like, may be implemented to fabricate 3D objects in build material particles 202. The build material particles 202 may include any suitable material for use in forming 3D objects. The build material particles 202 may include, for instance, a metal, a polymer, a plastic, a ceramic, a nylon, and/or combinations thereof, and may be in the form of a powder or a powder-like material. Additionally, the build material particles 202 may be formed to have dimensions, e.g., widths, diameters, or the like, that are generally between about 5 μm and about 100 μm. In other examples, the particles may have dimensions that are generally between about 30 μm and about 60 μm. The particles may have any of multiple shapes, for instance, as a result of larger particles being ground into smaller particles. In some examples, the particles may be formed from, or may include, short fibers that may, for example, have been cut into short lengths from long strands or threads of material. In addition, or in other examples, the particles may be partially transparent or opaque. According to one example, a suitable build material may be PA12 build material commercially known as V1R10A “HP PA12” available from HP Inc.

The 3D fabrication system 100 may include an agent delivery device 102, an energy generator 104, and a controller 110, as well as other components. During fabrication of a 3D object, the controller 110 may control the agent delivery device 102 to selectively deposit a fusing and/or binding agent 204 onto a layer 208 of build material particles 202 as denoted by the arrow 226. That is, for example, the controller 110 may control the agent delivery device 102 to deposit the fusing and/or binding agent 204 onto selected locations of the layer 208 of build material particles 202, in which the selected locations may correspond to locations that are to be bound or fused together to form part of a 3D object in the layer 208. In some examples, and as discussed herein, the agent 204 may include a first substance, such as water, or the like, and a second substance, which may include a solvent, an active material, or the like.

Although particular reference is made herein to a single agent 204, it should be understood that the agent delivery device 102 may deliver multiple types of agents and/or the 3D fabrication system 100 may include multiple agent delivery devices 102 to deliver the multiple types of agents without departing from a scope of the 3D fabrication system 100. Thus, it should be understood that the discussions directed to a single agent 204 may equally be applicable to multiple agents.

The energy generator 104 may generate energy, e.g., in the form of light and/or heat, and may be positioned to emit the generated energy toward the deposited agent 204 and the layer of build material particles 202 as denoted by the arrow 228. According to examples, the energy generator 104 may generate and emit the energy 228 at multiple selective levels. For instance, the energy generator 104 may generate energy at a first energy level, at a second energy level, etc. In some examples, the first energy level may be a first strength (e.g., intensity) level and the second energy level may be a second strength level. In addition or alternatively, the first energy level may correspond to a first wavelength and the second energy level may correspond to a second wavelength. In addition or alternatively, the energy generator 104 may provide energy in the form of short pulses in which the frequency and/or duration at which the energy is applied may be varied to apply energy at the different energy levels.

The energy generator 104 may generate the multiple energy levels through variable generation of energy from common energy generation elements, e.g., light emitting diodes (LEDs), or the like. In addition, or alternatively, the energy generator 104 may include multiple arrays of energy generators, in which one of the arrays 104-1 may generate energy at the first energy level and another one of the arrays 104-2 may generate energy at the second energy level. Although not explicitly described, the energy generator 104 may include other arrays that may generate energy at other energy levels.

As discussed herein, some of the energy levels may be tuned to different substances in the agents. For instance, a first energy level may be tuned to a first substance in the agent 204, e.g., tuned to an energy absorption property of the first substance, a second energy level may be tuned to a second substance in the agent 204, e.g., tuned to an energy absorption property of the second substance, and so forth. The energy absorption properties may correspond to the energy levels associated with evaporation of the first substance and the second substance, respectively. The energy absorption properties may also correspond to other properties of the first substance and the second substance, for instance, the mass values, the specific heat values, etc., of the first substance and the second substance. As used herein, an energy level that is “tuned” to a substance may be defined as an energy level that causes the substance to evaporate, e.g., causes the substance to reach a temperature at which the substance begins to boil, which may also factor a mass of the substance included in the agent 204.

In one regard, for instance, through sequential emission of the energy at the different energy levels, the multiple substances may be evaporated sequentially, which may result in an improved binding between the build material particles 202, e.g., metallic build material particles, upon which the agent 204 has been deposited. That is, for instance, the first substance may be evaporated (or equivalently, removed) from the agent 204 prior to evaporation of the second substance to cause a predefined reaction to occur in the agent 204. Although particular reference is made herein to a first substance and a second substance in the agent and thus a first energy level and a second energy level, it should be understood that features of the present disclosure may also apply to additional substances that the agent 204 may include as well as additional energy levels tuned to the additional substances.

The controller 110 may control operations of the 3D fabrication system 100 and may be a semiconductor-based microprocessor, a central processing unit (CPU), an application specific integrated circuit (ASIC), a field-programmable gate array (FPGA), and/or other suitable hardware device. In addition, the controller 110 may fetch, decode, and execute the machine-readable instructions 112-116 to control the agent delivery device 102 and the energy generator 104 based on properties, e.g., energy absorption properties, masses, compositions, etc., of the substances contained in the agent. Particularly, the controller 110 may fetch, decode, and execute the machine-readable instructions 112 to determine a first energy level tuned to the first substance of the agent. The first energy level may be tuned, for instance, to the boiling point temperature of the first substance. In some examples, the first substance may be a liquid, such as water, an alcohol, an organic substance (such as acetone, benzene, cyclopentane, hexane, 2-Metylbutane, etc.) or the like, and the first energy level may be an energy level that may cause the first substance to evaporate or otherwise cause the concentration level of the first substance to be reduced from the agent 204, such as through reaching a boiling point temperature of the liquid.

The controller 110 may also fetch, decode, and execute the machine-readable instructions 114 to determine a second energy level tuned to the second substance of the agent. The second energy level may be tuned to the boiling point temperature of the second substance. In some examples, the second substance may be a solvent, an organic solvent (such as 1,2-Butanediol, 2-Methyl-1,3-propanediol, Methyl-2-pyrrolidone, 1-propanol, 2-propanol, 2-Methyl-propanole, etc.) or the like, and the second energy level may be an energy level that may cause the second substance to evaporate or otherwise cause the concentration level of the second substance to be reduced from the agent 204, such as through reaching a boiling point temperature of the second substance.

In some examples, the controller 110 may determine the first energy level and the second energy level based on information contained in a lookup table that may identify correlations between the substances included in agents 204 and the energy levels to which the substances are tuned. The correlations between the substances and the respective energy levels to which the substances are tuned may have been previously determined through testing, modeling, results of prior fabrication processes, from publicly available information about the substances, and/or the like. In any regard, the lookup table may be stored in a data store 140, which the controller 110 may access to determine the first energy level and the second energy level. In some examples, the controller 110 may receive an instruction that may include an identification of the agent 204 and/or the first substance and the second substance and the controller 110 may identify the first substance and the second substance from the received instruction.

The controller 110 may further fetch, decode, and execute the machine-readable instructions 116 to control the energy generator 104 to sequentially emit energy 228 at the first energy level and at the second energy level onto the deposited agent 204 and the layer 208 of build material particles 202. That is, for instance, the controller 110 may have controlled the agent delivery device 102 to deposit the agent 204 onto a portion of the layer 208 of build material particles 202 as denoted by the arrow 226. Following the deposition of the agent 204 onto the portion of the layer 208, the controller 110 may control the energy generator 104 to emit energy 228 at the first energy level onto the deposited agent 204 and the portion of the layer 208 of build material particles 202. In addition, following emission of the energy 228 at the first energy level, the controller 110 may control the energy generator 104 to emit energy 228 at the second energy level onto the deposited agent 204 and the portion of the layer 208 of build material particles 202. Various manners in which the controller 110 may control the energy generator 104 are described in greater detail herein.

As shown in FIG. 2A, the 3D fabrication system 100 may include a spreader 206 (e.g., a roller) that may spread the build material particles 202 into a layer 208 (also referred to herein as a “build layer”), e.g., through movement across a platform 210 as indicated by the arrow 212. The 3D fabrication system 100 may also include forming components 214. The forming components 214 may include, for example, the agent delivery device 102, the energy generator 104, or another appropriate component based on the implementation. In some examples, the 3D fabrication system 100 may include a carriage 216 on which the forming components 214 may be mounted and scanned across the layer 208. The carriage 216 may be moved bi-directionally as indicated by the arrow 218. The forming components 214 may also be scanned in a direction perpendicular to the arrow 218 or in other directions. In addition, or alternatively, a platform 210 on which the layers 208 are deposited may be scanned in any of a number of directions with respect to the forming components 214.

The fabrication system 100 may include a build zone 224 (e.g., a powder bed) within which the forming components 214 may join and/or solidify selectively located build material particles 202 in the layer 208, e.g., to form part of a 3D object. According to examples, the controller 110 may control the agent delivery device 102 to deliver 226 the agent 204 as the agent delivery device 102 is scanned across the build zone 224. In addition, the controller 110 may control the energy generator 104 to emit energy 228 at the first energy level and then at the second energy level. In some examples, the energy generator 104 may be static with respect to the build zone 224 when sequentially emitting the energy 228 at the first energy level and at the second energy level. In other examples, the energy generator 104 may sequentially emit the energy 228 at the first energy level and the second energy level as the agent delivery device 102 is scanned across the build zone 224. As discussed herein, the controller 110 may control the energy generator 104 to emit energy onto the build zone 204 following delivery of the agent 204 onto the build zone 204.

Reference is now made to FIGS. 2B and 2C, which collectively show block diagrams of some of the components in the example 3D fabrication system 100 depicted in FIGS. 1 and 2A. Particularly, FIG. 2B shows a diagram that may depict the deposition 226 of an agent 204 and FIG. 2C shows a diagram that may depict the sequential application of energy 228 by a first energy generator 104-1 and a second energy generator 104-2.

As depicted in FIG. 2B, the controller 110 may control the delivery device 102 to deposit 226 the agent 204 onto a region of the build material particles 202 in the layer 208 and the agent 204 may include a plurality of substances. In some examples, the agent 204 may include a mixture of a first substance 230 (e.g., water), a second substance 232 (e.g., a solvent), and a third substance 234 (e.g., an active substance, such as a binder). In some examples, the active substance may be plastic nanoparticles.

According to examples, the controller 110 may control the energy generator 104 to apply energy 228-1 at a first energy level onto the portion of the layer 208. Following application of the energy 228-1 at the first energy level, the controller 110 may control the energy generator 104 to apply energy 228-2 at a second energy level onto the portion of the layer 208. In other examples, and as shown in FIG. 2C, the controller 110 may control the first energy generator 104-1 to emit energy at a first energy level, as depicted by the arrow 228-1 at a first time and may control the second energy generator 104-2 to emit energy at a second energy level at a second time following the first time.

According to examples, the second energy generator 104-2 may be spaced a certain distance from the first energy generator 104-1, in which the certain distance may correspond to a predefined timing between emission of the energy at the first energy level and emission of the energy at the second energy level. The predefined timing may correspond to the time during which a solvent (second substance 232) is to dissolve plastic nanoparticles (third substance 234) as discussed herein. The certain distance may also correspond to the speed at which the first energy generator 104-1 and the second energy generator 104-2 are moved across the layer 208 of build material particles 202. In some examples, the certain distance may correspond to an optimized spacing that may result in the plastic nanoparticles dissolving to an intended level.

In any of the examples discussed herein, the first energy level 228-1 may be tuned to the first substance 230 and the second energy level 228-2 may be tuned to the second substance 232. That is, the first energy level 228-1 may be an energy level that may cause the first substance 230 to reach or nearly reach the boiling point temperature of the first substance 230. In addition, the second energy level 228-2 may be an energy level that may cause the second substance 232 to reach or nearly reach the boiling point temperature of the second substance 230.

By way of example, the first energy level 228-1 may be tuned to an energy absorption property of the first substance 230, e.g., water, that facilitates evaporation of the first substance 230. As the first substance 230 begins to evaporate, the concentration of the first substance 230 in the agent 204 may be reduced, which may cause an increase in the concentration of the second substance 232, e.g., a solvent, to or above a predetermined concentration. When the concentration of the solvent 232 is at or above the predetermined concentration, the solvent 232 may begin to dissolve the third substance 234, e.g., the active substance. That is, the concentration of the solvent 232 in the agent 204 may be increased to the predetermined concentration or more as the concentration of the first substance 230, e.g., water, in the agent 204 decreases, which may cause the third substance 234, e.g., plastic nanoparticles, to begin to dissolve. As the third substance 234 begins to dissolve, the third substance 234 may flow such that the third substance 234 may coat some of the build material particles 202.

Once the dissolved third substance 234, e.g., dissolved plastic nanoparticles, have sufficiently flowed to coat some of the build material particles 202, the flow of the dissolved third substance 234 may be stopped, e.g., to prevent the flow of the dissolved third substance 234 beyond certain limits/edges and to facilitate accurate dimensions of a 3D printed object. In some examples, following a certain amount of time after the third substance 234 is caused to flow, e.g., once the flow of the agent 204 is sufficient for proper binding of the build material particles 202, the controller 110 may control the energy generator 104 to emit energy at the second energy level 228-2 to cause the flow to stop. For instance, the controller 110 may control the energy generator 104 to emit energy at the second energy level 228-2 to remove the second substance 232.

In some examples, the controller 110 may control the second energy generator 104-2 to emit energy 228-2, at a second, higher, energy level than the first energy level 228-1 to evaporate the second substance 232, e.g., solvent, from the agent 204. The second energy level 228-2 may depend on the energy absorbing properties of the second substance 232, e.g., heat absorption rate, light absorption rate, etc., of the second substance 232 included in the agent 204. The second energy level 228-2 may be tuned to an energy absorption property of the second substance 232, for example, the boiling point temperature of the second substance 232. By way of example, the application of energy 228-2 at the second energy level onto the agent 204 may cause the solvent 232 to evaporate, thereby reducing the concentration of the solvent 232 in the agent 204 to a level below the predetermined concentration. Once the concentration of the solvent 232 is reduced below the predetermined concentration, the plastic nanoparticles 234 that has coated some of the build material particles 202 may solidify and may bind the build material particles 202 together.

While the agent 204 has been described herein as having three substances 230-234, as depicted in FIG. 2B and 2C, it should be understood that the agent 204 may include any suitable number of substances. For example, in some examples, the agent 204 may include heat or energy absorbing agents (e.g., UV radiation absorber, IR radiation absorber, etc.), pigments, metal nanoparticles (e.g., Ag, Cu, Zn, metal alloys, or the like), a surfactant, a dispersant, biocides, an anti-kogation agent, a cooling liquid, or the like.

According to examples, the agent 204 may be a curable binder as discussed above. In other examples, the agent 204 may enhance absorption of the energy 228 by the build material particles 202 to cause the build material particles 202 upon which the agent 204 has been deposited to melt. According to one example, a suitable agent 204 may be an ink-type formulation including carbon black, such as, for example, the agent 204 formulation commercially known as V1Q60Q “HP agent 204” available from HP Inc. In one example, such an agent 204 may additionally include an infra-red light absorber. In one example such agent 204 may additionally include a near infra-red light absorber. In one example, such an agent 204 may additionally include a UV light absorber. In one example, such an agent 204 may additionally include a visible light absorber. In any of these examples, the absorbers may absorb wavelengths of energy emitted by the energy generators 104-1, 104-2. Examples of agents 204 including visible light enhancers are dye based colored ink and pigment based colored ink, such as inks commercially known as CE039A and CE042A available from HP Inc. According to one example, the 3D fabrication system 100 may additionally use a detailing agent. According to one example, a suitable detailing agent may be a formulation commercially known as V1Q61A “HP detailing agent” available from HP Inc.

According to examples in which the forming components 214 include a first energy generator 104-1 and a second energy generator 104-2, the controller 110 may cause the first energy generator 104-1 to emit energy at the first energy level 228-1 while the forming components 214 are moved in a first direction as denoted by a first direction of the arrow 218. The controller 110 may also cause the second energy generator 104-2 to emit energy at the second energy level 228-2 while the forming components 214 are moved in the first direction. However, when the forming components 214 are moved in a second direction as denoted by a second direction of the arrow 218, the controller 110 may cause the second energy generator 104-2 to emit energy at the first energy level 228-1 and the first energy generator 104-2 to emit energy at the second energy level 228-2. That is, the controller 110 may control the first energy generator 104-1 and the second energy generator 104-2 to apply energy at the first energy level 228-1 prior to applying energy at the second energy level 228-2 onto the agent 204 and the build material particles 202 regardless of the direction in which the carriage 216 moves.

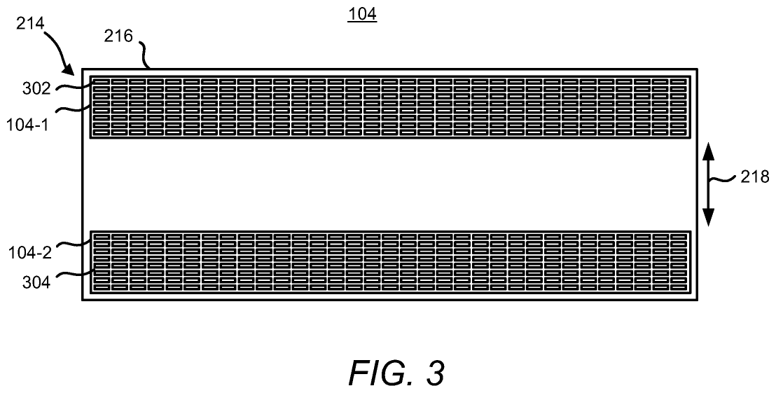

Reference is now made to FIG. 3, which shows a bottom view of an example energy generator 104, for instance, the example energy generator 104 depicted in FIGS. 1, 2A, and 2C. As depicted in FIG. 3, the energy generator 104 may be mounted on a bottom side of the carriage 216. In addition, the energy generator 104 may include a first energy generator 104-1 and a second energy generator 104-2 positioned at a certain distance from the first energy generator 104-1. The certain distance may correspond to a predefined timing at which energy at the first energy level and the second energy level are to be applied.

In some examples, the first energy generator 104-1 may include a first array of light emitting devices (LEDs) 302 and the second energy generator 104-2 may include a second array of LEDs 304. The controller 110 may separately control each of first array of LEDs 302 and the second array of LEDs 304. The controller 110 may also control individual ones of the LEDs in the first array 302 and in the second array 304. As discussed herein, the controller 110 may control the first array of LEDs 302 to emit energy at the first energy level 228-1 during a first pass of the carriage 214 and to emit energy at the second energy level 228-2 during a second pass of the carriage 214 in the directions of the arrow 218. Likewise, the controller 110 may control the second array of LEDs 304 to emit energy at the first energy level 228-1 during a second pass of the carriage 214 and to emit energy at the second energy level 228-2 during a first pass of the carriage 214 in the directions of the arrow 218.

While the first array of LEDs 302 and the second array of LEDs 304 have been described as respectively being the first energy generator 104-1 and the second energy generator 104-2, it should be understood that the first array of LEDs 302 may include any one or a group of LEDs 302 and/or 304. In some examples, the first array of LEDs may be a row of LEDs 302 positioned on the first energy generator 104-1 at a first leading edge (e.g., top edge in FIG. 3) of the carriage 216 and the second array of LEDs may be a row or multiple rows of LEDs 304 at a trailing edge (e.g., bottom edge in FIG. 3) of the carriage 216. In some examples, the first and second array of LEDs may be different rows or groups of LEDs 302 on the first energy generator 104-1.

In some examples, the LEDs may be high-power ultraviolet (UV) LEDs that may have sufficient power to generate energy levels suitable to heat various substances in agents 204, including agents 204 that are to bind metallic build material particles 202. In some examples, a width of an irradiated swath of the LEDs may be larger than or equal to a width of the build zone 224 (e.g., a width of up to 300 mm-400 mm). In some examples, build zone 224 heating may be performed in a stepwise manner (e.g., irradiate one swath and move to the next) as long as the rate of heating is sufficiently rapid. Alternatively, or in addition, an array of UV LEDs matching the first energy level and/or the second energy level may be constructed by grouping together additional UV LEDs. In some examples, focusing optics (not shown) may be used to lower cost and facilitate operation close to an irradiated surface to optimize irradiation energy. In some examples, the UV LED array may be placed as close as 1 mm to 3 mm from the surface of the layer 208 of the build material particles 202.

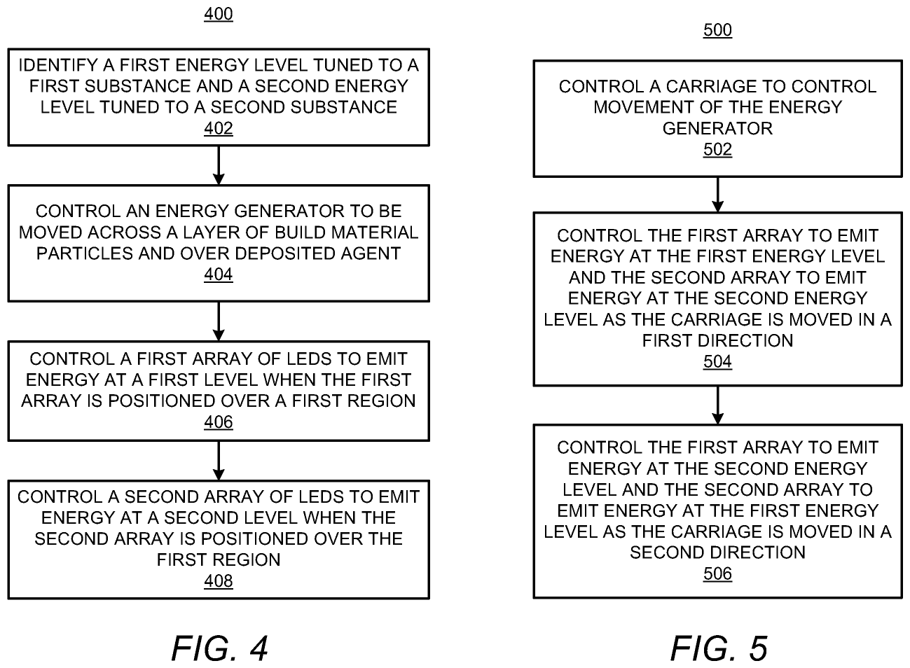

Turning now to FIGS. 4 and 5, there are respectively shown flow diagrams of example methods for controlling an energy generator 104 to sequentially apply energy at multiple levels onto a layer 208 of build material particles 202. It should be understood that the methods 400 and 500 depicted in FIGS. 4 and 5 may include additional operations and that some of the operations described therein may be removed and/or modified without departing from the scopes of the methods 400 and 500. The descriptions of the methods 400 and 500 are also made with reference to the features depicted in FIGS. 1-3 for purposes of illustration. Particularly, the controller 110 of the 3D fabrication system 100 may execute some or all of the operations included in the methods 400 and 500.

With reference first to FIG. 4, at block 402, the controller 110 may identify a first energy level 228-1 tuned to a first substance 230 and a second energy level 228-2 tuned to a second substance 232. As discussed herein, the first substance 230 and the second substance 232 may be included in an agent 204 deposited onto a layer 208 of build material particles 202. In addition, the first energy level 228-1 may correspond to an energy absorption property of the first substance 230 and the second energy level 228-2 may correspond to an energy absorption property of the second substance 232.

At block 404, the controller 110 may control an energy generator 104 to be moved 218 across a build area platform 210, e.g., across the layer of build material particles 202 and over the deposited agent 204. As discussed herein, the energy generator 104 may include a first energy generator 104-1 (e.g., a first array of LEDs 302) and a second energy generator 104-2 (e.g., a second array of LEDs 304). In any regard, the energy generator 104 may be supported on a carriage 216 that may move in the directions denoted by the arrow 218.

At bock 406, the controller 110 may control the first array of LEDs 302 to emit energy at the first energy level 228-1 when the first array 302 is positioned over a first region of the layer 208 of build material particles 202. As discussed herein, application of the energy at the first energy level 228-1 may cause the first substance 230 to evaporate or otherwise cause the concentration of the first substance 230 to be reduced from the deposited agent 204.

At block 408, the controller 110 may control the second array of LEDs 304 to emit energy at the second energy level when the second array 304 is positioned over the first region. As discussed herein, application of the energy at the second energy level 228-2 may cause the second substance 232 to evaporate or otherwise cause the concentration of the second substance 232 to be reduced from the deposited agent 204. In addition, the controller 110 may control the second array 304 to apply energy at the second energy level 228-2 following expiration of a certain amount of time from when energy at the first energy level 228-1 was applied. As a result, the concentration of the first substance 230 may be reduced prior to the reduction of the concentration of the second substance 232.

Referring to FIGS. 2A and 5, a carriage 216 may support the energy generator 104, in which the carriage 216 may be movable bi-directionally with respect to the build platform 210 and the layer 208 of build material particles 202. At block 502, the controller 110 may control the carriage 216 to control movement 218 of the energy generator 104 across the layer 208 of build material particles 202. At block 504, the controller 110 may control the first array 104-1 of LEDs 302 to emit energy at the first energy level 228-1 and the second array 104-2 of LEDs 304 to emit energy at the second energy level 228-2 as the carriage 216 is moved in the first direction across the layer 208 of build material particles 202. In some examples, the controller 110 may control the first array 114-1 of LEDs 302 to apply energy at the first energy level 228-1 onto a first area of the layer 208 of build material particles 202 and control the second array 114-2 of LEDs 304 to apply energy at the second energy level 228-2 onto the first area of the layer 208 of build material particles 202 following application of energy at the first energy level 228-1 on the first area. The application of the energy at the second energy level 228-2 may occur after a certain period of time has elapsed from when the energy at the first energy level 228-1 was applied as discussed herein.

At block 506, the controller 110 may control the first array 104-1 of LEDs 302 to emit energy at the second energy level 228-2 and the second array 104-2 of LEDs 304 to emit energy at the first energy level 228-1 as the carriage 216 is moved in a second direction across the layer 208 of build material particles 202. In some examples, the controller 110 may control the second array 114-2 of LEDs 304 to apply energy at the first energy level 228-1 onto a first area of the layer 208 of build material particles 202 and control the first array 114-1 of LEDs 302 to apply energy at the second energy level 228-2 onto the first area of the layer 208 of build material particles 202 following application of energy at the first energy level 228-1 on the first area. The application of the energy at the second energy level 228-2 may occur after a certain period of time has elapsed from when the energy at the first energy level 228-1 was applied as discussed herein.

Some or all of the operations set forth in the methods 400 and 500 may be contained as utilities, programs, or subprograms, in any desired computer accessible medium. In addition, the methods 400 and 500 may be embodied by computer programs, which may exist in a variety of forms. For example, the methods 400 and 500 may exist as machine readable instructions, including source code, object code, executable code or other formats. Any of the above may be embodied on a non-transitory computer readable storage medium.

Examples of non-transitory computer readable storage media include computer system RAM, ROM, EPROM, EEPROM, and magnetic or optical disks or tapes. It is therefore to be understood that any electronic device capable of executing the above-described functions may perform those functions enumerated above.

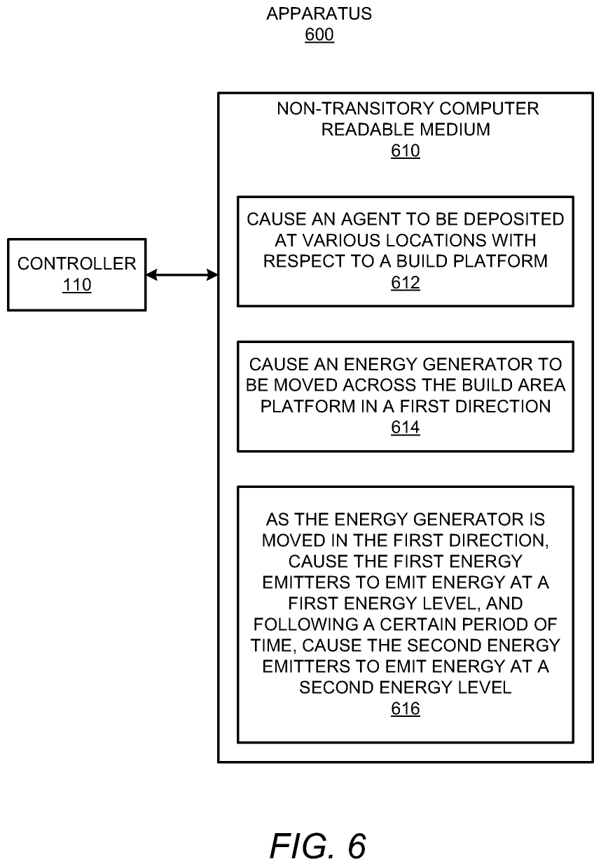

Turning now to FIG. 6, there is shown a block diagram 600 of an example apparatus 600 that may include a controller 110 and a non-transitory computer readable medium 610 on which is stored machine readable instructions 612-616 for causing an energy generator to emit energy onto an agent deposited onto a layer of build material particles. The controller 110 may execute the machine readable instructions 612-616. The description of the example apparatus 600 is made with reference to the features depicted in FIGS. 1-3 for purposes of illustration.

Particularly, at block 612, the controller 110 may execute the instructions 612 to cause an agent 204 to be deposited at various locations with respect to a build area platform 210, the agent 204 including a first substance 230 and a second substance 232. That is, the controller 110 may cause the agent 204 to be deposited at various locations on a layer 208 of build material particles 202 provided on the build area platform 210. At block 614, the controller 110 may cause an energy generator 104 to be moved across the build area platform 210 in a first direction. In some examples, the energy generator 104 may include first energy emitters 104-1 and second energy emitters 104-2.

At block 616, as the energy generator 102 is moved across the build area platform 210 in the first direction, the controller 110 may cause the first energy emitters 104-1 to emit energy at a first energy level 228-1 on a first location to reduce the concentration of the first substance 230 from the first location. Following a certain period of time, the controller 110 may cause the second energy emitters 104-2 to emit energy at a second energy level 228-2 to reduce the concentration of the second substance 232 from the first location.

In some examples, the instructions, when executed, may cause the controller 110 to cause the agent 204 to be deposited at a second location with respect to the build area platform 210. The controller 110 may further cause the energy generator 104 to be moved 218 across the build area platform 210 in a second direction. As the energy generator 104 is moved 218 across the build area platform 210 in the second direction, the controller 110 may cause the second energy emitters 104-2 to emit energy at the first energy level 228-1 on the second location to reduce the concentration of the first substance 230 from the second location. Following a certain period of time, the controller 110 may cause the first energy emitters 104-1 to emit energy at the second energy level 228-2 to reduce the concentration of the second substance 232 from the second location.

In some examples, the apparatus 600 may include a carriage 216 movable in the first direction and the second direction. In some examples, the carriage 216 may support the first energy emitters 104-1 and the second energy emitters 104-2. In a particular example, the first energy emitters 104-1 may be positioned at a first leading edge of the carriage 216 during movement 218 of the carriage 216 in the first direction and the second energy emitters 104-2 may be positioned at a second leading edge of the carriage 216 during movement 218 of the carriage 216 in the second direction. In any regard, the second energy emitters 104-2 may be spaced a certain distance apart from the first energy emitters 104-1 as discussed herein.

Although described specifically throughout the entirety of the instant disclosure, representative examples of the present disclosure have utility over a wide range of applications, and the above discussion is not intended and should not be construed to be limiting, but is offered as an illustrative discussion of aspects of the disclosure.

What has been described and illustrated herein is an example of the disclosure along with some of its variations. The terms, descriptions and figures used herein are set forth by way of illustration and are not meant as limitations. Many variations are possible within the scope of the disclosure, which is intended to be defined by the following claims—and their equivalents—in which all terms are meant in their broadest reasonable sense unless otherwise indicated.

What is claimed is:

1. A three-dimensional (3D) fabrication system comprising:
an agent delivery device to selectively deposit an agent onto a layer of build material particles, the agent including a first substance and a second substance;
an energy generator to emit energy at selective levels; and
a controller to:
determine a first energy level tuned to the first substance;
determine a second energy level tuned to the second substance; and
control the energy generator to sequentially emit energy at the first energy level and at the second energy level onto the deposited agent and the layer of build material particles.

2. The 3D fabrication system of claim 1, wherein the first energy level is tuned to an energy absorption property of the first substance and the second energy level is tuned to an energy absorption property of the second substance.

3. The 3D fabrication system of claim 2, wherein the agent comprises a binder including plastic nanoparticles and wherein:
the first substance is water and the energy absorption property of the first substance corresponds to an energy level associated with evaporation of water, and
the second substance is a solvent to dissolve the plastic nanoparticles in the agent, wherein the dissolved plastic nanoparticles are to bind to the build material particles, and wherein the energy absorption property of the second substance corresponds to an energy level associated with evaporation of the solvent.

4. The 3D fabrication system of claim 1, wherein the energy generator comprises a plurality of light emitting devices (LEDs).

5. The 3D fabrication system of claim 4, wherein the plurality of LEDs comprise a first array of LEDs and a second array of LEDs, wherein the first array of LEDs is spaced a certain distance from the second array of LEDs, and wherein the certain distance corresponds to a predefined timing between emission of the energy at the first energy level and emission of the energy at the second energy level.

6. The 3D fabrication system of claim 5, wherein the controller is to:
control the first array of LEDs to emit energy at the first energy level; and
control the second array of LEDs to emit energy at the second energy level.

7. The 3D fabrication system of claim 5, further comprising:
a build area platform;
a carriage movable bi-directionally with respect to the build area platform, the carriage supporting the energy generator; and
wherein the controller is further to:
control the first array of LEDs to emit energy at the first energy level and the second array of LEDs to emit energy at the second energy level as the carriage is moved in a first direction; and
control the first array of LEDs to emit energy at the second energy level and the second array of LEDs to emit energy at the second energy level as the carriage is moved in a second direction.

8. The 3D fabrication system of claim 1, further comprising:
a movable carriage, wherein the movable carriage supports the energy generator, and wherein controller is to control the energy generator to emit energy as the movable carriage is moved across the layer of build material particles to control the energy generator to sequentially emit energy at the first energy level and the second energy level.

9. A method comprising:
identifying, by a processor, a first energy level tuned to a first substance and a second energy level tuned to a second substance, the first substance and the second substance being in an agent deposited onto a layer of build material particles;
controlling, by the processor, an energy generator to be moved across the layer of build material particles and over the deposited agent, wherein the energy generator comprises a first array of light emitting devices (LEDs) and a second array of LEDs;
controlling, by the processor, the first array to emit energy at the first energy level when the first array is positioned over a first region of the layer of build material particles; and
controlling, by the processor, the second array to emit energy at the second energy level when the second array is positioned over the first region.

10. The method of claim 9, wherein the first energy level corresponds to an energy absorption property of the first substance and the second energy level corresponds to an energy absorption property of the second substance.

11. The method of claim 9, wherein the energy generator is supported on a carriage that is movable bi-directionally with respect to the layer of build material particles, the method further comprising:
controlling the carriage to control movement of the energy generator across the layer of build material particles;
controlling the first array of LEDs to emit energy at the first energy level and the second array of LEDs to emit energy at the second energy level as the carriage is moved in a first direction across the layer of build material particles; and
controlling the first array of LEDs to emit energy at the second energy level and the second array of LEDs to emit energy at the first energy level as the carriage is moved in a second direction across the layer of build material particles.

12. The method of claim 9, further comprising:
controlling the first array of LEDs to apply energy at the first energy level onto a first area of the layer of build material particles; and
controlling the second array of LEDs to apply energy at the second energy level onto the first area of the layer of build material particles following application of energy at the first energy level on the first area.

13. An apparatus comprising:
a controller; and
a non-transitory computer readable medium on which is stored machine readable instructions that when executed by the controller, cause the controller to:
cause an agent to be deposited at various locations with respect to a build area platform, the agent including a first substance and a second substance;
cause an energy generator to be moved across the build area platform in a first direction, the energy generator including first energy emitters and second energy emitters;
as the energy generator is moved across the build area platform in the first direction,
cause the first energy emitters to emit energy at a first energy level on a first location to reduce a concentration of the first substance from the first location; and
following a certain period of time, cause the second energy emitters to emit energy at a second energy level to reduce a concentration of the second substance from the first location.

14. The apparatus of claim 1, wherein the instructions are further to cause the controller to:
cause the agent to be deposited at a second location with respect to a build area platform;
cause the energy generator to be moved across the build area platform in a second direction;
as the energy generator is moved across the build area platform in the second direction,
cause the second energy emitters to emit energy at the first energy level on the second location to reduce a concentration of the first substance from the second location; and
following the certain period of time, cause the first energy emitters to emit energy the second energy level to reduce a concentration of the second substance from the second location.

15. The apparatus of claim 14, further comprising:
a carriage movable in the first direction and the second direction, the carriage supporting the first energy emitters and the second energy emitters, and wherein the first energy emitters are positioned at a first leading edge of the carriage during movement of the carriage in the first direction and wherein the second energy emitters are positioned at a second leading edge of the carriage during movement of the carriage in the second direction.
